(19) United States
(12) Patent Application Publication
(10) Pub. No.: US 2020/0124826 A1
(43) Pub. Date: Apr. 23, 2020

(54) CEMENTED LENS AND IN-VEHICLE CAMERA

(71) Applicant: DENSO CORPORATION, Kariya-city (JP)

(72) Inventors: Masashi KITSUNEZUKA, Kariya-city (JP); Soji MASUI, Kariya-city (JP); Tomonori ISHIKAWA, Kariya-city (JP); Takashi AOKI, Kariya-city (JP); Osamu FUJIWARA, Kariya-city (JP)

(21) Appl. No.: 16/709,139

(22) Filed: Dec. 10, 2019

Related U.S. Application Data
(63) Continuation of application No. PCT/JP2018/024165, filed on Jun. 26, 2018.

(30) Foreign Application Priority Data
Jun. 30, 2017 (JP) 2017-128873

(51) Int. Cl. G02B 13/00; H04N 5/225

(52) U.S. Cl. CPC G02B 13/006; G02B 7/02; H04N 5/2254

(57) ABSTRACT

A cemented lens includes a first lens, a second lens and a cementation layer. The first lens includes a convex surface. The second lens includes a concave surface. The cementation layer cements the convex surface to the concave surface. The cementation layer includes a resin and a gap material.

This application is a U.S. application under 35 U.S.C. 111(a) and 363 that claims the benefit under 35 U.S.C. 120 from International Application No. PCT/JP2018/024165 filed on Jun. 26, 2018, the entire contents of which are incorporated herein by reference. The present application also claims the benefit of a priority from Japanese Patent Application No. 2017-128873 filed in Japan Patent Office on Jun. 30, 2017 the entire contents of Japanese Patent Application No. 2017-128873 are incorporated herein by reference.

### BACKGROUND

### Technical Field

The present disclosure relates to a cemented lens and an in-vehicle camera.

### Background Art

Cemented lenses are known which are lenses obtained by joining lenses via a joining layer.

### SUMMARY

An aspect of the present disclosure is a cemented lens including a first lens having a convex surface, a second lens having a concave surface, and a cementation layer that cements the convex surface to the concave surface. In the cemented lens, the cementation layer comprises a gap material.

### BRIEF DESCRIPTION OF THE DRAWINGS

FIG. 1 is a diagram illustrating an arrangement of an image sensor in a vehicle.

FIG. 2 is a diagram illustrating configurations of an image sensor and an in-vehicle camera.

FIG. 3 is a sectional view illustrating a configuration of a cemented lens.

### DETAILED DESCRIPTION OF THE PREFERRED EMBODIMENTS

With reference to the drawings, some embodiments of the present disclosure will be described.

The inventors have performed thorough research and found some issues as set forth below. Cemented lenses are considered to be used, for example, in-vehicle cameras. In-vehicle cameras may be exposed to extreme temperature environments. In-vehicle cameras need to have long-lasting durability.

Depending on the temperature environments of an in-vehicle camera, the cementation layer forming the cemented lens may suffer from thermal strain. If thermal strain is repeatedly caused in a cementation layer, cloudiness called balsam separation occurs in the cementation layer in the conventional cemented lenses, for example, disclosed in JP 2010-243966 A. Due to the cloudiness, imaging accuracy of the in-vehicle camera is deteriorated. In an aspect of the present disclosure, it is preferable to provide a cemented lens that can minimize the occurrence of cloudiness in a cementation layer, and an in-vehicle camera.

An aspect of the present disclosure is a cemented lens including a first lens having a convex surface, a second lens having a concave surface, and a cementation layer that cements the convex surface to the concave surface. In the cemented lens, the cementation layer comprises a resin and a gap material.

According to the cemented lens that is an aspect of the present disclosure, cloudiness is unlikely to occur in the cementation layer even when a thermal strain is caused in the cementation layer.

The bracketed reference signs in the claims indicate correspondence with the specific means described in the following embodiments, which are each described as a mode, and do not limit the technical scope of the present disclosure.

### 1. CONFIGURATIONS OF AN IMAGE SENSOR 1 AND AN IN-VEHICLE CAMERA 3

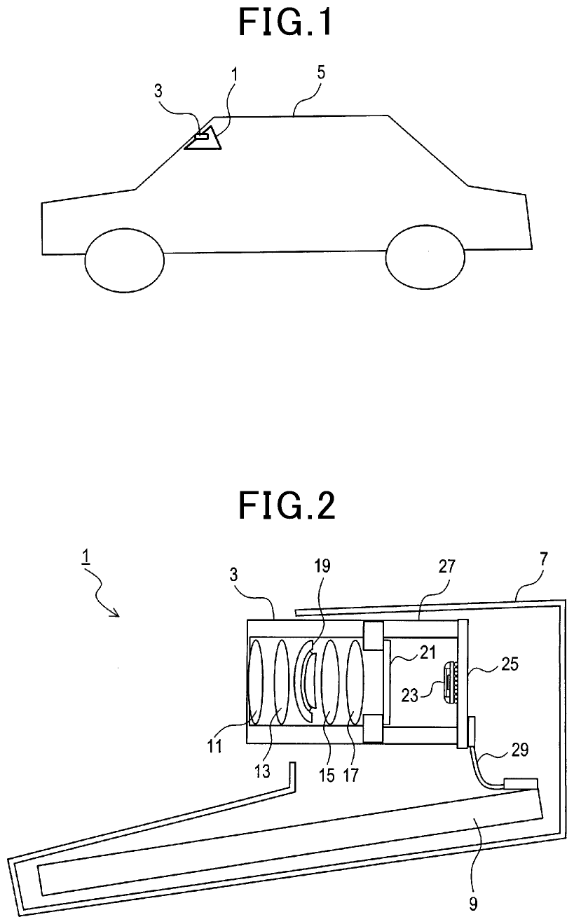

Referring to FIGS. 1 and 2, an image sensor 1 and an in-vehicle camera 3 will be described. As shown in FIG. 1, the image sensor 1 is mounted to a vehicle 5. As shown in FIG. 2, the image sensor 1 includes an in-vehicle camera 3, a casing 7 and a substrate 9.

The in-vehicle camera 3 includes lenses 11, 13, 15 and 17, a cemented lens 19, a filter 21, an imager 23, a printed-circuit board 25 and a camera case 27.

The lenses 11, 13, 15 and 17 and the cemented lens 19 configure an optical system of the in-vehicle camera 3. The configuration of the cemented lens 19 will be described later. The filter 21 cuts off light of a predetermined wavelength range. The imager 23 converts light into an electrical signal. The printed-circuit board 25 holds electronic parts, including the imager 23. The camera case 27 houses components of the in-vehicle camera 3. The in-vehicle camera 3 captures an image of around the vehicle 5 and produces the image. The in-vehicle camera 3 captures an image, for example, in forward, rearward and lateral directions or other directions of the vehicle 5.

The camera case 27 houses the in-vehicle camera 3 and the substrate 9. The substrate 9 and the printed-circuit board 25 are connected to each other via a harness 29. The substrate 9 acquires an image produced by the in-vehicle camera 3 via the harness 29. The substrate 9 analyzes the acquired image and executes a process of driving assistance. The driving assistance includes, for example, collision avoidance, advanced driving assistance, lane keeping assist or automated cruise.

### 2. CONFIGURATION OF THE CEMENTED LENS 19

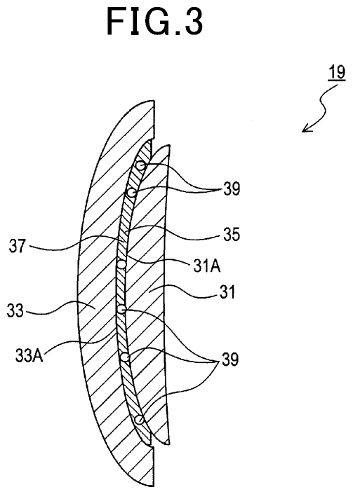

Referring to FIG. 3, a configuration of the cemented lens 19 will be described. The cemented lens 19 includes a convex lens 31, a concave lens 33 and a cementation layer 35. The convex lens 31 includes a convex surface 31A. The concave lens 33 includes a concave surface 33A. The convex lens 31 corresponds to the first lens. The concave lens 33 corresponds to the second lens. The cementation layer 35 cements the convex surface 31A and the concave surface 33A.

The cementation layer 35 includes a resin 37 and a gap material 39. For example, the resin 37 is an active energy ray curable resin. If the resin 37 is an active energy ray curable resin, the process of curing the resin 37 may be facilitated. For example, the active energy ray curable resin may be an ultraviolet ray curable resin, or the like. For example, the resin 37 may contain one or more resins selected from a group consisting of a silicone resin, an acrylic resin, an epoxy resin and a polyester resin. If the resin 37 contains one or more resins selected from a group consisting of a silicone resin, an acrylic resin, an epoxy resin and a polyester resin, the cloudiness of the cementation layer 35 can be minimized even more.

The gap material 39 is comprised of a plurality of particles. The particle size, for example, is in the range of 1 μm to 30 μm, and more preferably in the range of 3 μm to 10 μm. If the particle size is in the range of 1 μm to 30 μm, the cloudiness of the cementation layer 35 can be minimized even more. If the particle size is in the range of 3 μm to 10 μm, the cloudiness of the cementation layer 35 can be particularly minimized even more. The method of measuring the particle size is as follows.

1 g of gap material 39 is mixed with 5 g of surfactant, followed by adding ultrapure water 30. Then, the gap material is dispersed by using an ultrasonic disperser to thereby prepare a measurement sample. Then, an average particle size of the measurement sample is measured by using a precise particle size distribution measuring device. The measured average particle size is taken to be a particle size of the gap material 39. The precise particle size distribution measuring device is a Coulter Multisizer manufactured by Beckman Coulter, Inc. The aperture diameter to be used is 50 μm.

The particles forming the gap material 39 are dispersed in the sea of the resin 37. When the mass of the cementation layer 35 is 100 parts by mass, the mass of the gap material 39 is preferably in the range of 0.02 parts by mass to 0.5 parts by mass. If the mass is within this range, the cloudiness of the cementation layer 35 can be minimized even more.

For example, the gap material 39 is comprised of an organic composition. Examples of the organic composition include an acrylic resin, a styrene resin, a polyester resin, a polyethylene resin, a polypropylene resin, a polycarbonate resin and silicone resin. When the gap material 39 is comprised of an organic composition, the absolute value of the difference in refractive index is small between the gap material 39 and the resin 37 (the difference is termed refractive index difference hereinafter). Therefore, light scattering can be minimized at the interface between the gap material 39 and the resin 37.

The method of measuring the refractive indices of the gap material 39 and the resin 37 is as follows. 0.5 g of gap material 39 is added to a high refractive index solvent. The high refractive index solvent is carbon disulfide. Next, while the high refractive index solvent containing the gap material 39 is stirred, a low refractive index solvent is dripped into it. The low refractive index solvent is ethanol. After dripping a predetermined amount of the low refractive index solvent, the liquid becomes transparent. The composition ratio between the high and low refractive index solvents when the liquid just become transparent is determined to be a critical ratio. The refractive index of the mixed solvent containing the high and low refractive index solvents at the determined composition ratio is measured by using an Abbe refractometer manufactured by Atago Co., Ltd. The measurement result is taken to be the refractive index of the gap material 39.

A plate-shaped sample made of the resin 37 and having a thickness of 0.1 mm is prepared. The refractive index of this plate-shaped sample is measured by using an Abbe refractometer manufactured by Atago Co., Ltd. The measurement result is taken to be the refractive index of the resin 37. The light used for measuring the refractive index is D-line light. The D-line light is a light beam having a wavelength of 589 nm.

If the gap material 39 is comprised of an organic composition, the convex lens 31 or the concave lens 33 can be prevented from being damaged by the gap material 39. Also, if the gap material 39 is comprised of an organic composition, the gap material 39 is unlikely to precipitate in an adhesive described later. Therefore, the content of the gap material 39 in the cementation layer 35 is stable. The gap material 39 may be comprised of an inorganic material. Examples of the inorganic material include inorganic fillers, such as alumina, aluminum hydroxide, magnesium hydroxide, calcium carbonate, talc, magnesium carbonate, calcium silicate, magnesium silicate, calcium oxide, magnesium oxide, aluminum oxide, aluminum nitride, quartz, amorphous silica, zirconium dioxide, boron nitride, titania, glass and iron oxide.

The particles forming the gap material 39 may each have, for example, a spherical shape, indefinite shape, fibrous shape, scaly shape, atypical shape, or the like. The particles forming the gap material 39 may preferably have a spherical shape. If the particles forming the gap material 39 have a spherical shape, unevenness in thickness of the cementation layer 35 can be reduced. Also, if the particles forming the gap material 39 have a spherical shape, air is unlikely to be mixed in the adhesive, which is described later, when the adhesive is produced.

The spherical shape herein is not limited to a spherical shape in the strict sense. As long as advantageous effects similar to those set forth above are achieved, the spherical shape does not have to be a spherical shape in the strict sense.

Preferably, CV in the particle size distribution of the gap material 39 is 15 or less, and particularly preferably, 10 or less. If CV is 10 or less, the unevenness in thickness of the cementation layer 35 can be reduced. CV refers to coefficient of variation and is also called coefficient of change or displacement coefficient. CV is a value obtained by dividing a standard deviation of particle size of the gap material 39 by an average value of particle size of the gap material 39.

The refractive index difference may preferably be 0.01 or less. If the refractive index difference is 0.01 or less, light scattering can be minimized at the interface between the gap material 39 and the resin 37.

In the cementation layer 35, a portion corresponding to an effective optical surface of the cemented lens 19 can be ensured not to include the gap material 39. In this case, the optical characteristics of the in-vehicle camera 3 are prevented from being affected by the gap material 39. In the cementation layer 35, at least a part of the portion not corresponding to the effective optical surface of the cemented lens 19 can be permitted to include the gap material 39. The cementation layer 35 may include a component other than the resin 37 and the gap material 39.

### 3. METHOD OF PRODUCING THE CEMENTED LENS 19

For example, the cemented lens 19 can be produced as follows. An uncured resin is mixed with a component containing the gap material 39 to prepare an adhesive. In this case, the gap material 39 is dispersed in the sea of the uncured resin.

For example, the resin may be an active energy ray curable resin, or the like. The active energy ray curable resin may be an ultraviolet ray curable resin, or the like. If the resin is an active energy ray curable resin, the adhesive may preferably contain an active energy ray polymerization initiator. For example, the resin may contain one or more resins selected from a group consisting of a silicone resin, an acrylic resin, an epoxy resin and a polyester resin.

Next, the adhesive is applied to one or both of the convex surface 31A and the concave surface 33A. Next, the convex surface 31A and the concave surface 33A are cemented each other via the applied adhesive. Next, the adhesive is cured. If the adhesive contains an active energy ray curable resin, the adhesive may be cured by applying an active energy ray thereto. The active energy ray, for example, may be ultraviolet ray, or the like. The resin contained in the adhesive is cured and serves as the resin 37. The layer of the adhesive serves as the cementation layer 35. For example, the curing reaction may be radical polymerization, cationic polymerization, thiol-en reaction, condensation reaction, or the like.

### 4. ADVANTAGEOUS EFFECTS ACHIEVED BY THE CEMENTED LENS 19

Even when thermal strain occurs in the cementation layer 35, cloudiness is unlikely to occur. The reason can be considered as follows. The cementation layer 35 has a larger thickness due to containing the gap material 39, compared to the layer not containing the gap material 39, and thus the thickness is stable. Consequently, if a thermal strain occurs in the cementation layer 35, the stress applied to the resin 37 is alleviated, so that cloudiness is unlikely to occur.

### 5. EXAMPLES

### (5-1) Example 1

0.16 phr of a gap material was added to a lens adhesive and the resultant material was mixed and stirred by using a vacuum planetary stirrer. The lens adhesive was WR5515 manufactured by Kyoritsu Chemical and Co., Ltd. The lens adhesive contained an uncured ultraviolet ray curable resin. The ultraviolet ray curable resin corresponds to the active energy ray curable resin. The gap material was Soliostar RA/B50X manufactured by Nippon Shokubai Co., Ltd. The gap material was comprised of a plurality of particles. The particle size was 5 μm. The particles each had a spherical shape. The material for the gap material was an organic-inorganic hybrid material. CV was 6.2 in the distribution of the particles forming the gap material. The vacuum planetary stirrer was a VRA-210 manufactured by Thinky Corporation. The mixing and stirring conditions were 2,000 rpm, 3 minutes and 3.0 kPa.

As a result of the mixing and stirring, an adhesive containing a gap material was obtained. In the adhesive containing a gap material, the gap material was uniformly dispersed.

A convex lens and a concave lens were prepared. The adhesive containing a gap material was dripped on the concave surface of the concave lens. The concave surface of the concave lens was cemented to the convex surface of the convex lens via the dripped adhesive containing a gap material. After aligning the lenses with each other, light was applied to the lenses by using a UV irradiator under conditions of 100 mJ/cm² to precure the adhesive containing a gap material. In this case, the optical axes of the convex and concave lenses were in alignment.

Next, the lenses were irradiated with light in a batch UV curing furnace under conditions of 6,000 mJ/cm², and the adhesive containing a gap material was completely cured, thereby completing a cemented lens. In the cemented lens, the cured layer of the adhesive containing a gap material formed a cementation layer. The cementation layer contained a resin and a gap material. The absolute value of the difference in refractive index was 0.002 between the gap material and the resin. The maximum thickness of the cementation layer was 12.8 μm, and the minimum thickness thereof was 5.7 μm.

Materials used for producing the cemented lens, structure of the cementation layer, and the like are shown in Table 1.

TABLE 1

| | | | | Compar- | Compar- |
|---|---|---|---|---|---|
| | | | | ative | ative |
| | Example 1 | Example 2 | Example 3 | Example 1 | Example 2 |
| Adhesive | WR5515 | WR5517 | WR5515 | WR5515 | WR5517 |
| Gap material | Soliostar | Soliostar | Soliostar | Absent | Absent |
| | RA/B50X | RA/B50X | RA/E48X | | |
| Refractive | 0.002 | 0.010 | 0.032 | — | — |
| index | | | | | |
| difference | | | | | |
| Particle size | 5 μm | 5 μm | 4.8 μm | — | — |
| of gap | | | | | |
| material | | | | | |
| Thickness of | 12.8 μm | 13.5 μm | 12.3 μm | 10.5 μm | 11.2 μm |
| cementation | | | | | |
| layer (max.) | | | | | |
| Thickness of | 5.7 μm | 6.2 μm | 5.4 μm | 0.5 μm | 0.7 μm |
| cementation | | | | | |
| layer (min.) | | | | | |
| Initial optical | ⊚ | ⊚ | Δ | — | — |
| character- | | | | | |
| istics | | | | | |
| Ratio of | 0/10 | 0/10 | 0/10 | 7/10 | 2/10 |
| cloudiness | | | | | |
| occurred | | | | | |

### (5-2) Example 2

A cemented lens was produced basically as in Example 1. However, in the present example, WR5517 manufactured by Kyoritsu Chemical and Co., Ltd was used as a lens adhesive instead of WR5515. WR5517 contained an uncured ultraviolet ray curable resin.

The absolute value of the difference in refractive index was 0.010 between the gap material and the resin contained in the cementation layer. The maximum thickness of the cementation layer was 13.5 μm, and the minimum thickness thereof was 6.2 μm. Materials used for producing the cemented lens, structure of the cementation layer, and the like are shown in Table 1 set forth above.

### (5-3) Example 3

A cemented lens was produced basically as in Example 1. However, in the present example, Soliostar RA/E48X manufactured by Nippon Shokubai Co., Ltd. was used as a gap material instead of Soliostar RA/650X. The Soliostar RA/E48X was comprised of plurality of particles. The particle size was 4.8 μm. The particles each had a spherical shape. The material for the Soliostar RA/E48X was an organic-inorganic hybrid material. CV was 6.5 in the distribution of the particles forming the Soliostar RA/E48X.

The absolute value of the difference in refractive index was 0.032 between the gap material and the resin contained in the cementation layer. The maximum thickness of the cementation layer was 12.3 μm, and the minimum thickness thereof was 5.4 μm. Materials used for producing the cemented lens, structure of the cementation layer, and the like are shown in Table 1 set forth above.

### (5-4) Comparative Example 1

A cemented lens was produced basically as in Example 1. However, in Comparative Example 1, no gap material was added to the lens adhesive. Accordingly, the cementation layer did not include a gap material. The maximum thickness of the cementation layer was 10.5 μm, and the minimum thickness thereof was 0.5 μm. Compared to Examples 1 to 3, thickness variation of the cementation layer was large. Materials used for producing the cemented lens, structure of the cementation layer, and the like are shown in Table 1 set forth above.

### (5-5) Comparative Example 2

A cemented lens was produced basically as in Example 2. However, in Comparative Example 2, no gap material was added to the lens adhesive. Accordingly, the cementation layer did not include a gap material. The maximum thickness of the cementation layer was 11.2 μm, and the minimum thickness thereof was 0.7 μm. Compared to Examples 1 to 3, thickness variation of the cementation layer was large. Materials used for producing the cemented lens, structure of the cementation layer, and the like are shown in Table 1 set forth above.

### (5-6) Evaluations for Initial Optical Characteristics

Initial optical characteristics of the cemented lenses of Examples 1 to 3, and Comparative Examples 1 and 2 were evaluated as follows. Each cemented lens was incorporated into a camera module. Error of the camera module was measured. Then, the measured error was compared with a comparative object to calculate an increase/decrease of the error. The comparative object for Examples 1 and 3 was Comparative Example 1. The comparative object for Example 2 was Comparative Example 2. Based on the calculated error of increase, initial optical characteristics of each cemented lens were evaluated with reference to the following criteria. Table 1 shows the evaluations.

⊚: Increase of error was less than 10%.

∘: Increase of error was 10% or more and less than 20%.

Δ: Increase of error was 20% or more.

Evaluations for initial optical characteristics were good in Examples 1 and 2. The reason is considered to reside in the small refractive index difference of Examples 1 and 2.

### (5-7) Cloudiness Generation Test

Tests were conducted for the cemented lenses of Examples 1 to 3, and Comparative Examples 1 and 2. In the tests, a thermal shock was applied to each cemented lens to examine the occurrence of cloudiness in the cementation layer. The tests were each conducted as follows. Each cemented lens was housed in a thermal shock tester. One cycle was defined to be leaving the cemented lens at 120° C. for 30 minutes and then leaving the cemented lens at −40° C. for 30 minutes. This cycle was repeated 2,000 times. After that, the outer periphery of the cementation layer was observed with a microscope to examine whether cloudiness had occurred. The above test was conducted for each lens. In the test, the number of lens samples tested, denoted by N, was 10. Of 10 cemented lenses, the ratio of those which had caused cloudiness is shown in the above Table 1. In Examples 1 to 3, none of the 10 cemented lenses caused cloudiness. However, cloudiness was caused at a high ratio in Comparative Examples 1 and 2.

The reason why cloudiness was not caused in Examples 1 to 3 can be considered as follows. The cementation layers of Examples 1 to 3 including a gap material each have a larger thickness compared to the cementation layers of Comparative Examples 1 and 2 including no gap material. Accordingly, the thickness in Examples 1 to 3 is stable. As a result, even when a thermal strain occurs in the cementation layer, the stress applied to the resin is alleviated, and accordingly, cloudiness is unlikely to occur.

### 6. OTHER EMBODIMENTS

An embodiment of the present disclosure has been described so far, but the present disclosure is not limited to the embodiment described above and can be implemented in various modes.

(1) The cemented lens 19 may be used for cameras other than an in-vehicle camera 3.

(2) The first lens 31 having the convex surface 31A may be a lens other than a convex lens. The second lens 33 having the concave surface 33A may be a lens other than a concave lens.

(3) In each embodiment described above, a plurality of functions of one component may be implemented by a plurality of components, or one function of one component may be implemented by a plurality of components. Alternatively, a plurality of functions of a plurality of components may be implemented by one component, or one function implemented by a plurality of components may be implemented by one component. Alternatively, a part of the configuration may be omitted from each embodiment described above. Alternatively, at least a part of the configuration of each embodiment described above may be added to or replaced by the configuration of another embodiment described above. It should be noted that any mode encompassed by the technical idea specified by the language of the claims is an embodiment of the present disclosure.

(4) Besides the in-vehicle camera 3 and the image sensor 1 described above, the present disclosure can be implemented in various modes, including a system having the in-vehicle camera 3 and the image sensor 1 as components, a program for causing a CPU in the substrate 9 to execute a driving assistance process, a non-transitory tangible recording medium such as a semiconductor memory in which the program is recorded, a method of producing the cemented lens 19, and the like.

What is claimed is:

1. A cemented lens comprising:
a first lens having a convex surface;
a second lens having a concave surface; and
a cementation layer that cements the convex surface and the concave surface, wherein
the cementation layer comprises a resin and a gap material, and
the gap material is comprised of a plurality of particles, whose particle size is in the range of 1 μm to 30 μm.

2. The cemented lens according to claim 1, wherein the gap material comprises particles having a spherical shape.

3. The cemented lens according to claim 1, wherein the gap material is comprised of an organic composition.

4. The cemented lens according to claim 1, wherein an absolute value of a difference in refractive index is 0.01 or less between the gap material and the resin.

5. The cemented lens according to claim 1, wherein the resin is an active energy ray curable resin.

6. The cemented lens according to claim 1, wherein a portion corresponding to an effective optical surface in the cementation layer does not comprises the gap material.

7. An in-vehicle camera comprising the cemented lens according to claim 1.
